(19) United States
(12) Patent Application Publication
(10) Pub. No.: US 2011/0227721 A1
(43) Pub. Date: Sep. 22, 2011

(54) Leak detection system for pipes

(76) Inventors: Khaled Mezghani, Dhahran (SA); Rached Ben-Mansour, Dhahran (SA)

(21) Appl. No.: 12/659,807

(22) Filed: Mar. 22, 2010

(51) Int. Cl. G08B 1/08

(52) U.S. Cl. 340/539.1

(57) ABSTRACT

The leak detection system for pipes and couplings is a system for generating an alert signal when a liquid leak from the pipe joint or coupling is detected. The leak detection system includes a transmitter mounted adjacent a pipe joint formed between a first pipe and a fitting of a second pipe. A pair of contacts have first ends electrically connected to the transmitter and second ends extending into an annular recess formed in the pipe joint. The second ends have a gap formed between each other. When an electrically conductive liquid leaks from the pipe joint, the liquid fills the gap between the contacts, closing a transmitting circuit, activating the transmitter to transmit an alert signal.

### BACKGROUND OF THE INVENTION

1. Field of the Invention

The present invention relates generally to water pipes in a water supply or distribution system, and particularly to a leak detection system for pipes and couplings that generates an alert signal when a liquid leak from a pipe joint or coupling is detected.

2. Description of the Related Art

Water leaks in homes, businesses and distribution networks cause a tremendous amount of damage to structures and contents. Leaks generally occur from a burst water pipe or leaking faucets or water using appliances. If an occupant is present and the leak is easily visible, water damage can often be prevented. However many leaks occur behind cabinets and in the walls so that even if an occupant is present, the leaks may not be discovered until a very substantial amount of damage has been caused. It is not uncommon for an undetected leak to literally create havoc and require major reconstruction to return the building to a usable state. Moreover, leaks induce the growth of hazardous mold.

Typical conventional pipeline leak detection systems are relatively inefficient in terms of response time, sensitivity, robustness and cost. Pipeline leaks are typically detected by observation of the external effects of the spill, or by monitoring and analysis of the internal hydraulics of the pipeline. Neither of these methods provides real-time monitoring of the leak itself, only the indirect effects of a leak. One of the objectives of a pipeline leak detection system is to alert operators so that the size of the spill can be limited, thus rapid detection, as well as reliability and sensitivity, are critical factors in a pipe leak detector.

Thus, a leak detection system for pipes solving the aforementioned problems is desired.

### SUMMARY OF THE INVENTION

The leak detection system for pipes and couplings generates an alert signal when a liquid leak from a pipe joint or coupling is detected. The leak detection system for pipes includes a transmitter mounted adjacent a pipe joint formed between a pipe and a fitting. A pair of contacts have first ends electrically connected to the transmitter and second ends spaced apart from each other by a gap in an annular recess formed in fitting. In use, if an electrically conductive liquid leaks from the pipe joint, the electrically conductive liquid fills the gap formed between the second ends of the wires, closing a circuit that activates the transmitter, causing the transmitter to transmit an alert signal.

These and other features of the present invention will become readily apparent upon further review of the following specification and drawings.

### BRIEF DESCRIPTION OF THE DRAWINGS

FIG. 1 is an environmental perspective view of a leak detection system for pipes and couplings according to the present invention.

FIG. 2 is a partial side view in section of the leak detection system for pipes and couplings according to the present invention.

FIG. 3 is a diagrammatic view of an alternative embodiment of a leak detection system for pipes and couplings according to the present invention.

FIG. 4 is a partial side view in section of another alternative embodiment of a leak detection system for pipes and couplings according to the present invention.

FIG. 5 is a section view through the pipes in another alternative embodiment of a leak detection system for pipes and couplings of FIG. 4.

FIG. 6 is a schematic diagram of a transmitter for a leak detection system for pipes and couplings according to the present invention.

Similar reference characters denote corresponding features consistently throughout the attached drawings.

### DETAILED DESCRIPTION OF THE PREFERRED-EMBODIMENTS

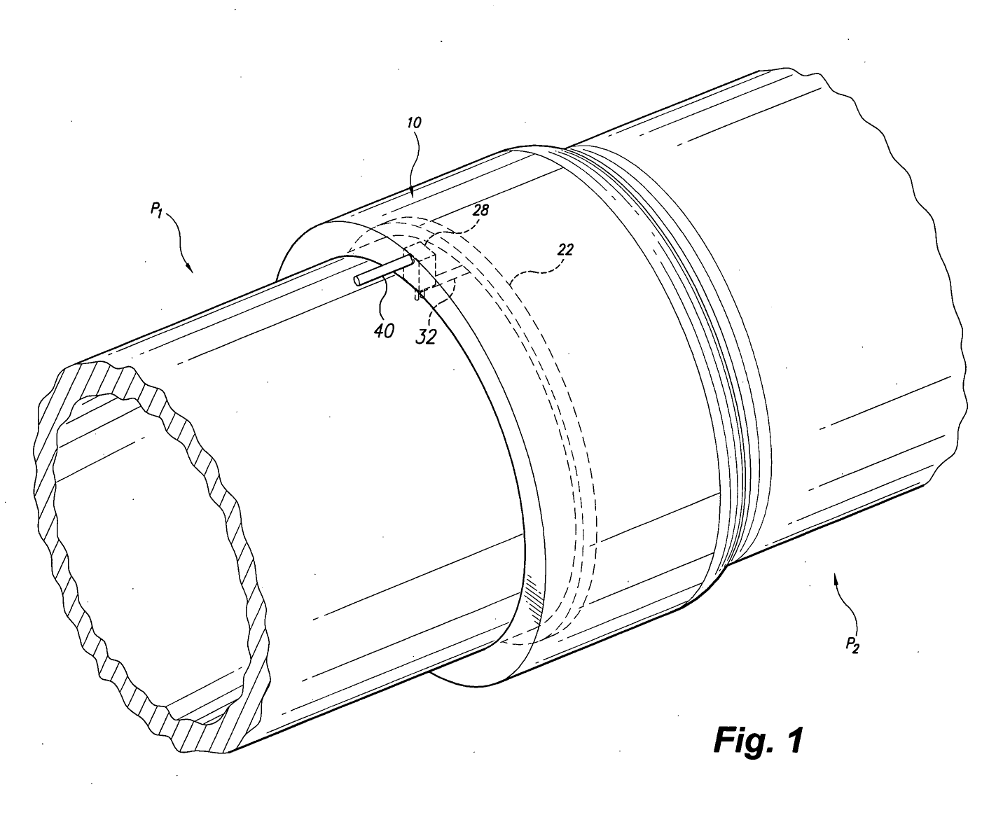

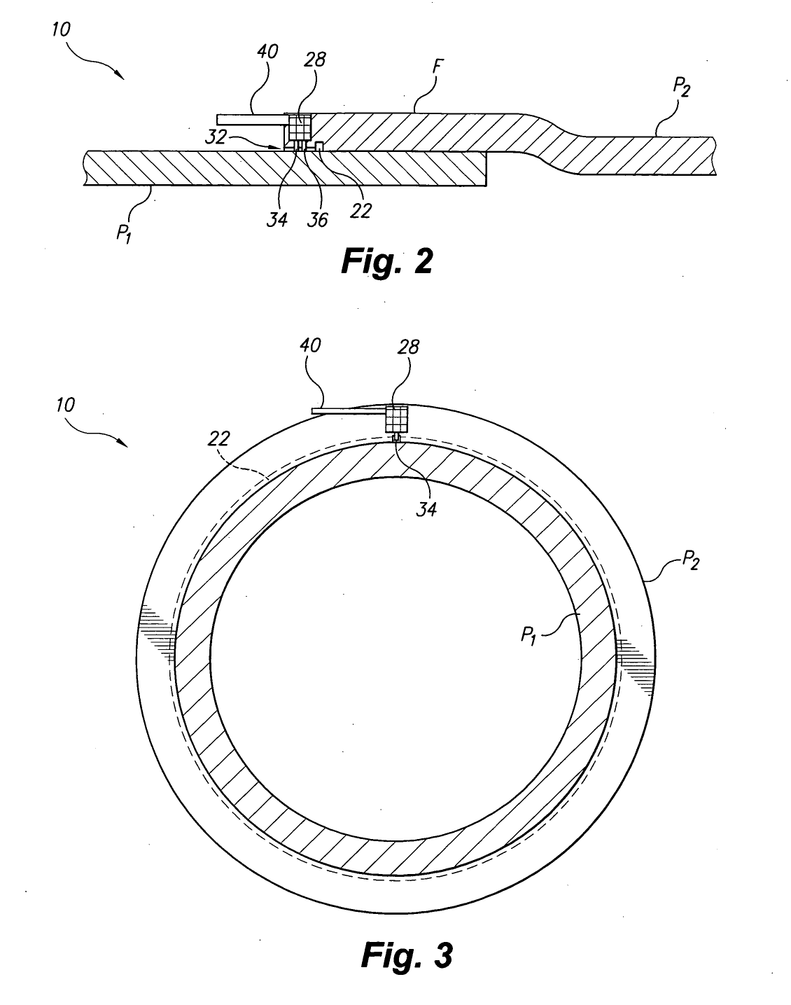

FIGS. 1-3 show a first embodiment of a leak detection system for pipes and couplings 10 for generating an alert signal when a liquid leak from a pipe joint or coupling is detected. In FIGS. 1-3, an exemplary pipe joint is formed between a pipe P₂ having a fitting F and a second pipe P₁ seated in the fitting F, with solder or PVC cement forming a seal in the fitting. Over a period of time, the seal may deteriorate so that the pipes leak. As best shown in FIG. 2, an annular recess 22 is formed in an interior surface of the fitting F.

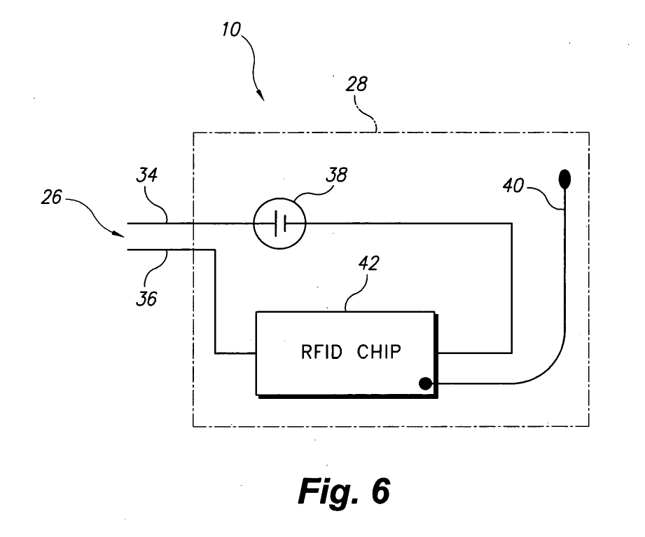

A transmitter 28 is embedded within pipe P₂ at the edge of the fitting F, and a pair of contacts 34, 36 (which may be prongs, wires, plates, or other electrical conductors) extend from the transmitter 28 into the liquid leak channel 32, the contacts 34, 36 being spaced apart by a small gap. Although it should be understood that any suitable type of transmitter 28 may be used, in the preferred embodiment, as shown in FIG. 6, the transmitter 28 preferably includes a radio frequency identification (RFID) chip 42 or the like, a battery 38 or other suitable source of electrical power in electrical communication with the radio frequency identification chip 42, and an antenna 40 in electrical communication with the radio frequency identification chip 42.

Each contact 34, 36 has opposed a first end electrically connected to the transmitter 28. The spaced apart second ends act like switch contacts, activating the transmitter 28 when connected by conductive material bridging the gap. Preferably, as shown in FIG. 2, the annular recess 22 collects the conductive fluid and guides it towards the liquid leak channel 32, where both contacts 34, 36 are embedded.

In FIGS. 1 and 2, the antenna 40 of transmitter 28 projects along a direction substantially parallel to the axes of pipe lengths P₁ and P₂, and is mounted on the edge of the fitting F. It should be understood that antenna 40 may have any desired orientation allowing for unobstructed transmission of an alert signal. In FIG. 3, the antenna 40 is shown being positioned substantially orthogonal to the axial direction of FIGS. 1 and 2, projecting substantially tangentially to the outer surface of pipe P₂. Antenna 40 may be mounted to pipe P₂ by any suitable type of mounting or attachment, or may be partially embedded within pipe P₂, as shown in FIG. 2.

In use, if an electrically conductive liquid leaks from the pipe joint formed between pipe lengths P₁ and P₂, the electrically conductive liquid (it is assumed that water in the water supply or sewage or drain is sufficiently ionic to be electrically conductive) fills the gap 32 formed between the contacts 34, 36, thus closing a transmitting circuit formed by the transmitter 28 and the contacts 34, 36, activating the transmitter to transmit an alert signal to a remote user or receiver.

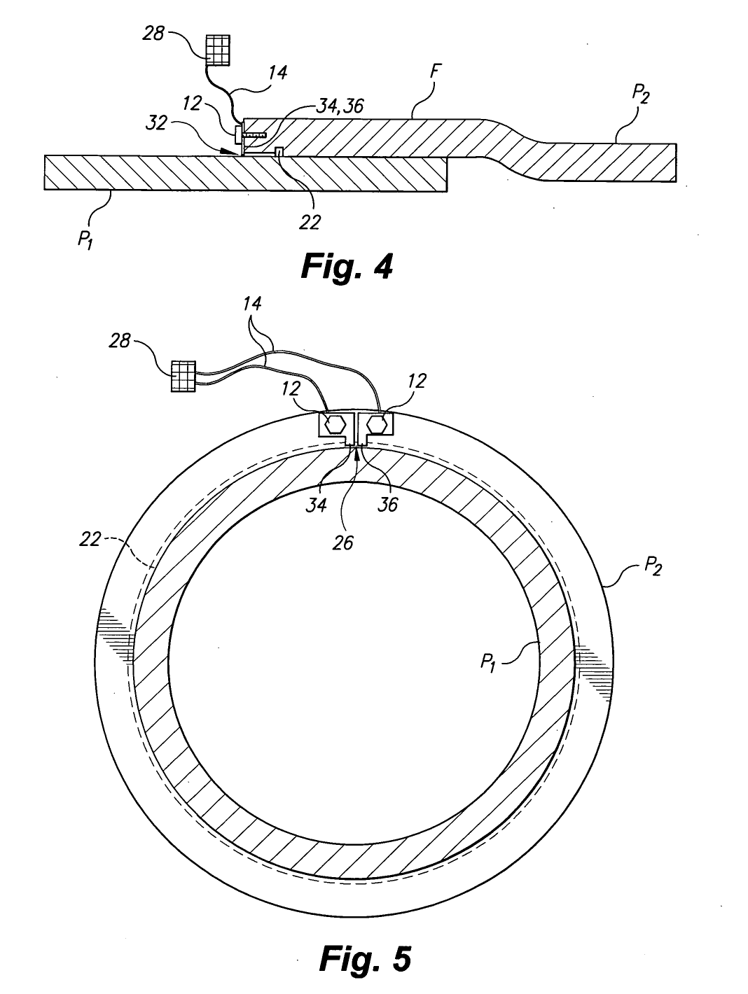

In the embodiment of FIGS. 2 and 3, the contacts 34, 36 are positioned within the liquid leak channel 32. In the alternative embodiment of FIGS. 4 and 5, the contacts 34, 36 are positioned external to the pipe joint at the end of the fitting F, partially covering the open end of the liquid leak channel 32, as shown. Contacts 34, 36 may be secured to the annular edge of the fitting F by screws 12 or the like, as shown. In this embodiment, the transmitter 28 is positioned external to pipe P₂, electrically connected to leads 34, 36 by wires 14. The transmitter 28, which may have antenna 40 integrated therein as a solid state unit, may be positioned on the external surface of pipe P₂, or on any other suitable external mounting surface adjacent the pipe joint.

It is to be understood that the present invention is not limited to the embodiments described above, but encompasses any and all embodiments within the scope of the following claims.

We claim:

1. A leak detection system, comprising:
a transmitter mounted adjacent a pipe joint formed between a first pipe and a fitting of a second pipe, the fitting having a recess defined therein adjacent the first pipe; and
a pair of contacts having first ends electrically connected to the transmitter and second ends extending into the annular recess between the first pipe and the fitting, the second ends being separated from each other by a gap, the contacts closing a transmitter circuit when an electrically conductive liquid leaks from the pipe joint into the gap between the contacts, the closed transmitter circuit activating the transmitter to transmit an alert signal to a remote receiver warning of a leak in the pipe joint.

2. The leak detection system as recited in claim 1, wherein said transmitter comprises:
a radio frequency identification chip;
a battery in electrical communication with the radio frequency identification chip; and
an antenna in electrical communication with the radio frequency identification chip.

3. The leak detection system as recited in claim 1, wherein the annular recess is adapted for accumulating the leaked electrically conductive liquid, the annular recess defining a liquid leak channel, the liquid leak channel being formed between the first pipe and the fitting of the second pipe.

4. The leak detection system as recited in claim 3, wherein the second ends of the pair of contacts extend into the liquid leak channel.

5. The leak detection system as recited in claim 1, wherein said transmitter is embedded within the fitting.

6. The leak detection system as recited in claim 5, wherein the transmitter has an antenna extending at least partially external to the fitting.

7. The leak detection system as recited in claim 6, wherein the antenna extends along a direction substantially parallel to an axis of the second pipe.

8. The leak detection system as recited in claim 6, wherein the antenna extends along a direction substantially normal to an axis of the second pipe.

9. A leak detection system, comprising:
a transmitter mounted adjacent a pipe joint formed between a first pipe and a fitting of a second pipe the fitting having an edge and defining an annular recess between the first pipe and the second pipe extending to the edge of the fitting; and
a pair of contacts mounted on the edge of the fitting, each of the contacts having a first end electrically connected to the transmitter and a second end extending to the first pipe adjacent the annular recess between the first pipe and the second pipe, the second ends being separated by a gap, the contacts closing a transmitter circuit when an electrically conductive liquid leaks from the pipe joint into the gap between the contacts, the closed transmitter circuit activating the transmitter to transmit an alert signal to a remote receiver warning of a leak in the pipe joint.

10. The leak detection system as recited in claim 9, wherein said transmitter comprises:
a radio frequency identification chip;
a battery in electrical communication with the radio frequency identification chip; and
an antenna in electrical communication with the radio frequency identification chip.

11. The leak detection system as recited in claim 10, wherein the annular recess is adapted for accumulating the leaked electrically conductive liquid, the annular recess defining a liquid leak channel, the liquid leak channel being formed between the first pipe and the fitting of the second pipe.

12. A leak detection system, comprising:
a first pipe adapted for fluid flow therein, the first pipe having an end;
a second pipe adapted for fluid flow therein, the second pipe having an end forming a fitting, the end of the first pipe being seated in the fitting and sealed thereto to form a pipe joint, the fitting having an annular recess defined therein encircling the first pipe within the pipe joint;
a transmitter having a circuit configured for transmitting an alert signal to a remote receiver when the transmitter is activated and a switch circuit for activating the transmitter;
a pair of contacts, each of the contacts having a first end electrically connected to the switch circuit for activating the transmitter and a second end extending into the annular recess, the second ends being separated by a gap, wherein the switch circuit is closed when fluid leaks from the pipe joint into the recess and the gap between the second ends of the contacts, thereby activating the transmitter to transmit the alert signal.

13. The leak detection system according to claim 12, wherein said transmitter is embedded within said fitting.

14. The leak detection system according to claim 12, wherein said transmitter is disposed external to said fitting.

15. The leak detection system according to claim 12, wherein said transmitter comprises an RFID chip.

16. The leak detection system according to claim 12, wherein said fitting has an edge, said contacts being mounted on the edge of the fitting, the annular recess extending to the edge of the fitting.
